(19) United States
(12) Patent Application Publication
(10) Pub. No.: US 2010/0287813 A1
(43) Pub. Date: Nov. 18, 2010

(54) Slidable Fishing Device

(76) Inventor: Tom Moritz, Kendall Park, NJ (US)

Correspondence Address: HOFFMANN & BARON, LLP, 6900 JERICHO TURNPIKE, SYOSSET, NY, 11791, US

(21) Appl. No.: 12/467,646

(22) Filed: May 18, 2009

(51) Int. Cl. A01K 91/04

(52) U.S. Cl. 43/43.1; 43/44.9; 43/44.87

(57) ABSTRACT

The present invention provides a slidable fishing device including: a tubular member having an inner wall and an outer wall; a discontinuous region longitudinally aligned along a side of the tubular member, the discontinuous region configured to allow passage of a line from the outer wall to the inner wall of the tubular member and retain the line therein; and a ring portion projecting to the tubular member, the ring portion configured to attach at least one tackle member, wherein the tubular member slidably retains the line along the inner wall.

### FIELD OF THE INVENTION

The present invention relates to a slidable fishing device for use with a fishing line and pole. Specifically, the present invention relates to a slidable fishing device with a discontinuous portion that allows the device to be removably attached to the fishing line, with no moving parts.

### RELATED ART

Sliding sinker designs allow the sinker to slide along the length of a fishing line. Sinker-slider devices typically used in fishing must be installed by cutting the line to provide a free end for insertion into the device. Similarly, once installed, the line must be cut in order to remove the device. Other designs include movable parts, where the fisherman needs to rotate the device to attach the line then rotate again to close the ferrule to create a closed ferrule. Devices with a rotatable ferrule design have moving parts, which may be cumbersome to use and may fail with repeated use. Thus, the current designs for sliding sinkers have various disadvantages associated with their use. Therefore, there exists a need for a sliding sinker design that is easy to manufacture and is easy and efficient for fishermen to use while fishing.

### SUMMARY OF THE INVENTION

An embodiment of the present invention includes a slidable fishing device. The slidable fishing device includes: a tubular member having an inner wall and an outer wall; a discontinuous region longitudinally aligned along a side of the tubular member, the discontinuous region configured to allow passage of a line from the outer wall to the inner wall of the tubular member and retain the line therein; and a ring portion projecting from the tubular member, the ring portion configured to engage or attach to at least one tackle member, wherein the tubular member slidably retains the line along the inner wall.

Another embodiment of the present invention provides a slidable fishing device. The slidable fishing device includes a generally tubular member having an inner wall and an outer wall; a discontinuous region along the generally tubular member, the discontinuous region providing an open ferrule to the tubular member wherein the open ferrule is configured to allow the removable attachment of the slidable fishing device onto a line from the outer wall to the inner wall of the tubular member and retain the line therein; and a ring portion projecting to the tubular member, the ring portion configured to attach to at least one tackle member, wherein the tubular member slidably retains the line along the inner wall.

Still another embodiment of the present invention provides a slidable fishing device which includes: a tubular member having an inner wall and an outer wall; a discontinuous region having a first region and a second region, the first region of the discontinuous region having a distance from a first edge to a second edge of the discontinuous region that is shorter than the first and second edge of the second region, wherein the discontinuous region is longitudinally aligned along a side of the tubular member and is configured to allow a line to pass into the central portion of the tubular member and be retained therein along the inner wall; and a ring portion projecting from the tubular member, the ring portion configured to engage or attach to at least one tackle member, wherein the tubular member slidably retains the line along the inner wall.

The present invention may be better understood through a study of the following drawings and detailed description.

### BRIEF DESCRIPTION OF THE DRAWINGS

FIG. 1 depicts a front plan view of an embodiment of the present invention.

FIG. 2 depicts a side plan view of an embodiment of the present invention.

FIG. 3 depicts an enlarged view of portion A on FIG. 2.

FIG. 4 depicts a perspective side view of another embodiment of the present invention.

FIG. 5 depicts a front plan view of another embodiment of the present invention.

FIG. 6 depicts a opposite side view of another embodiment of the present invention.

FIG. 7 depicts a side plan view of another embodiment of the present invention.

FIG. 8 depicts an enlarged view of portion B on FIG. 7.

FIG. 9 depicts a perspective side view of another embodiment of the present invention.

FIG. 10 depicts a front plan view of still another embodiment of the present invention.

FIG. 11 depicts a perspective top view of still another embodiment of the present invention.

FIG. 12 depicts a side plan view of still another embodiment of the present invention.

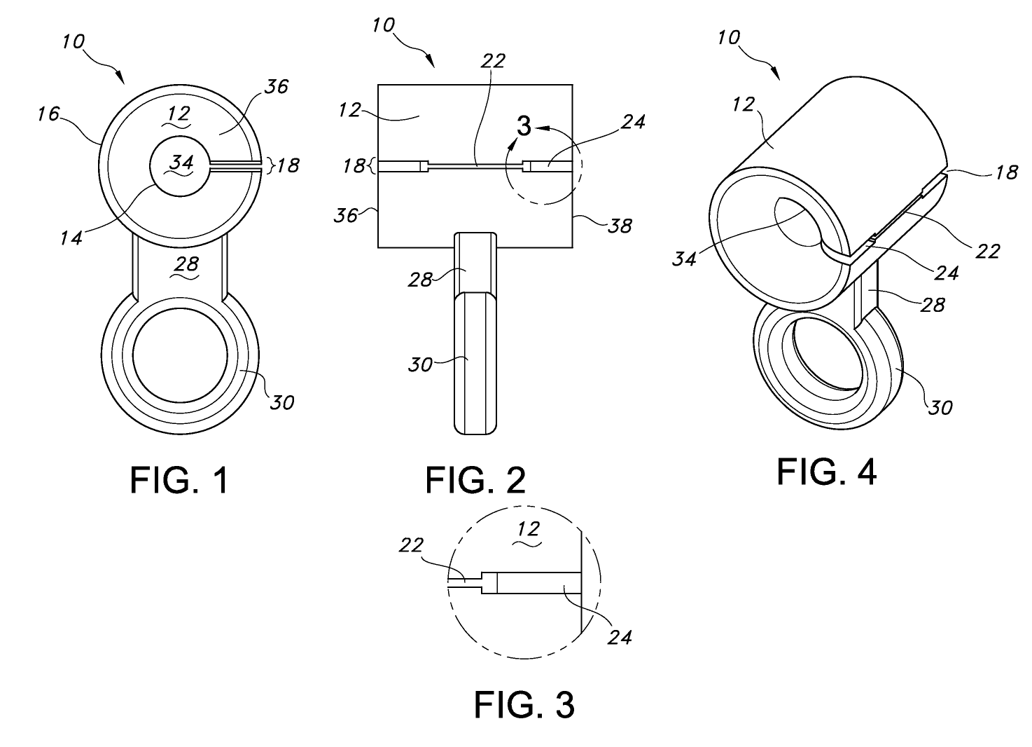

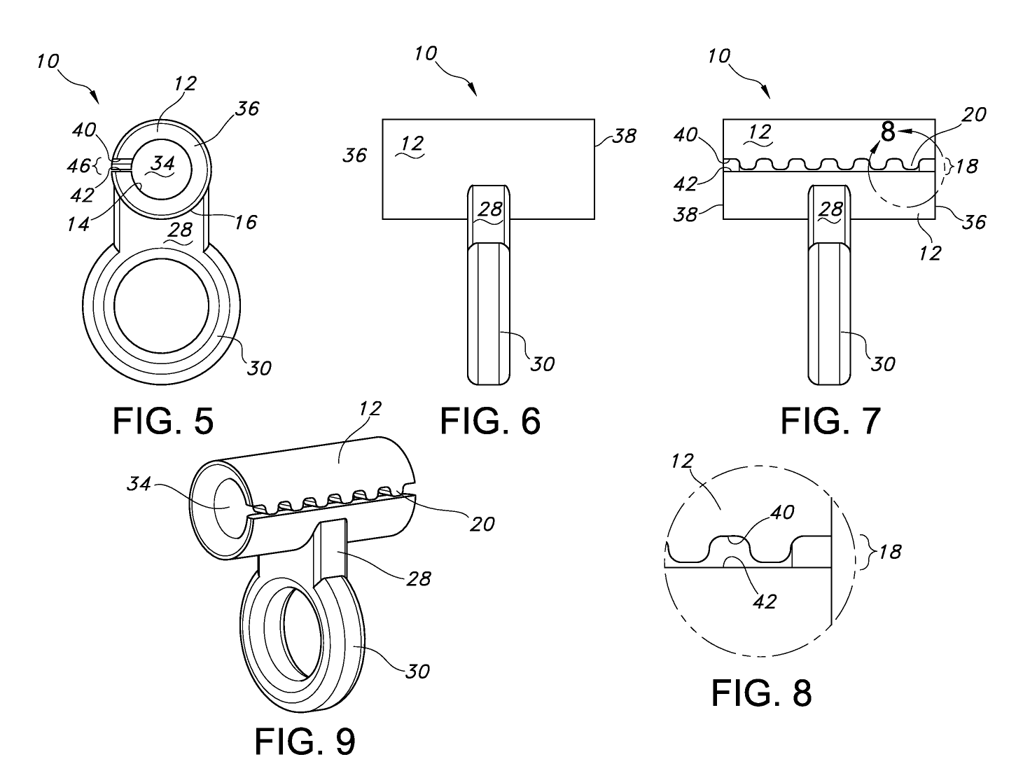

### DETAILED DESCRIPTION OF THE DRAWINGS

The various embodiments of the present invention are directed to solving the problems in the art, with various advantages described herein. The invention generally relates to a slidable fishing device. The slidable fishing device may include a discontinuous region. The discontinuous region may include an open ferrule design, such that the tackle and/or line may be removably attached therefrom. Thus, the open ferrule slidable sinker design may overcome the problems associated with the previous designs, while providing an effective slidable fishing device that is easy to use and durable. The device is shown in the figures and described in the drawings, where like reference numerals denote like parts throughout.

In reference to the Figures, the slidable fishing device 10 is shown. The slidable fishing device 10 includes a tubular member 12 and at least one ring portion 30 projecting therefrom. The tubular member 12 and the ring portion 30 may be connected or attached to one another by a neck 28. The tubular member 12, ring portion 30, and optional neck 28 may be integrally formed and/or molded together, or may also be attached to one another, for example, by welding, fasteners, mating threaded parts, adhesive material, or combination thereof.

The tubular member 12 may be a generally cylindrical shape, though various geometric shapes may be employed. The tubular member 12 generally includes an inner wall 14 and an outer wall 16, and the tubular member 12 has opposing ends, a first end 36 and a second end 38. The tubular member 12 may also have a discontinuous region 18. The discontinuous region 18 may run along the length of the tubular member 12 parallel to the longitudinal axis of the tubular member 12.

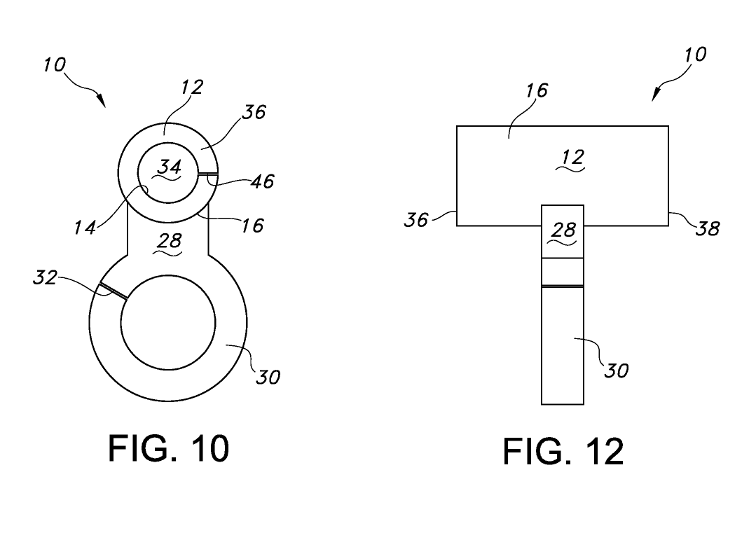

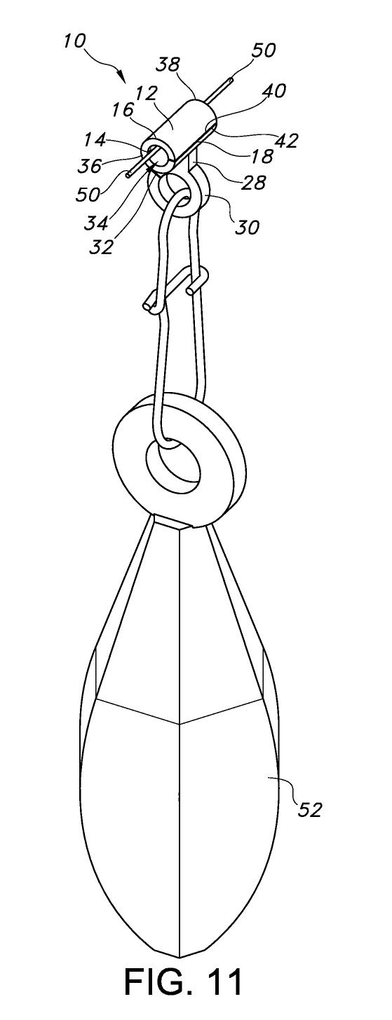

The ring portion 30 is configured to allow engagement with, e.g. the attachment of, at least one tackle member 52. The ring portion 30 may be attached to or integral with the tubular member 12, so that it may project from a portion of the outer wall 16 of the tubular member 12. The tackle member 52 may be hooked, tied or otherwise connected onto the ring portion 30, as may be desired. Optionally, the ring portion 30 may include a slit 32 on said ring portion 30. This is shown, for example, in FIGS. 10, 11, and 12. Thus, the slit 32 may allow a tackle member 52 to be readily attached onto the ring portion 30 of the slidable fishing device 10. Additionally, in the event a tackle member, like a sinker, encounters a snag (i.e. gets lodged in rocks or debris) and cannot be removed, the slit in the ring portion provides a breakaway point allowing the fisherman to retrieve the line without additional loss of tackle. As such, the slit 32 of the ring portion 30 may retain the tackle member 52 thereon.

The tubular member 12 and the ring portion 30 may be oriented in one or more fashions, as may be desired. For example, the tubular member 12 and the ring portion 30 may be aligned as shown in the figures, aligned perpendicularly to one another, or angled in varying degrees. Further, either of the tubular member 12 or the ring portion 30 may be configured in one or more shapes or forms, as may be desired. For example, one or more of the tubular member 12 or the ring portion 30 may have a profile shape that is cylindrical (as shown in the Figures), oblong, hexagonal, triangular, pentagonal, et cetera.

The discontinuous region 18 may be configured to allow a line 50 to pass there through. Through the discontinuous region 18, the line 50 may be pushed, pulled, or otherwise angled from the outer wall 16 of the tubular member 12 through the discontinuous region and into the inner wall 14. Further, the discontinuous region 18 may be configured to retain the line 50 inside of the central portion 34, the area inside of the tubular member 12. The central portion 34 may be, for example, the hollow portion of the inner wall 14 of the tubular member (as shown in FIG. 9), or alternatively, a very small open in the central portion 34 (as shown in FIG. 4). The discontinuous region 18 is desirably configured as an open ferrule 46. The open ferrule 46 may refer to one or more various configurations of the discontinuous region 18 where the line 50 may be removably attached to the slidable fishing device 10 without, for example, crimping, clamping, swiveling parts of, or otherwise moving the tubular member 12 to close the discontinuous region 18 into a closed ferrule design.

The tubular member 12 may be configured such that a wide variety of sized fishing lines, including both monofilament and braided line varieties may be accommodated. Many varieties and sizes may be fit through the discontinuous region 18 onto the slidable fishing device 10. As such, the slidable fishing device 10 may hold the fishing line 50 in a slidably adjustable manner, while attaching a sinker or other fishing accessory to the line 50. The slidable fishing device 10 may be composed of one or more materials, as may be desired. For example, the slidable fishing device 10 may be composed of lead, plastic, polymer, steel, metal, and combinations thereof.

The discontinuous region 18 may be located along a side of the tubular member 12 that is spaced from the uppermost portion of the tubular member 12, while spaced apart from the side of the tubular member 12 site where the neck 28 and/or ring portion 30 are attached. In such a manner, the discontinuous region 18 may be configured to allow a line to pass into the central portion 34 of the tubular member 12 and be retained therein along the inner wall 14. Thus, the discontinuous region 18 is preferably located along either side of the device 10. Desirably, the discontinuous region is located at least 30 degrees to about 90 degrees from either of the top most portion of the tubular member 12 and the ring portion 30. Most desirably, the discontinuous region is located at about 90 degrees from the central axis as measured from a radial bisection of the tubular member.

The discontinuous region 18 may take one or more forms, as may be desired. As the slidable fishing device 10 may be composed of, for example, polymer or plastic, the discontinuous region 18 may simply be a slot 44 in the discontinuous region 18. Thus, the slot 44 may be visible to a user, as for example, a faint line across the tubular member 12 of the device 10, but otherwise appear that the edges 40, 42 or the discontinuous region 18 touch. As the material from which the tubular member 12 is composed may be semi-rigid enough to hold the line yet pliable so as to yield to direct pressure along the discontinuous region 18, the line 50 may be inserted into the slot 44 so as to attach the slidable fishing device 10. Fishing line 50 is also generally partially flexible, whether it is monofilament or a braided line, thus both the line 50 and the discontinuous region 18 edges 40, 42, may partially flex to allow the line 50 into the central portion 34 of the tubular member 12.

As another example, the discontinuous region 18 may be at least one lip 20. The lip 20 may be an extension of or an attachment to either of the first or second edges 40, 42 of the discontinuous region 18. The lip 20 may be longitudinally aligned along at least a portion of the discontinuous region 18. The lip 20 may be configured to allow passage of a line 50 from the outer wall 16 to the inner wall 14 of the tubular member 12 and retain the line 50 therein. The discontinuous region 18 may only be one lip 20 that extends at least a portion along one of the two edges 40, 42 of the discontinuous region 18. Further, the discontinuous region 18 may include a plurality of lips 20. The lips 20 may be arranged along either of the edges 40, 42, or along both of the edges, 40, 42, in one or more patterns as may be desired. Thus, the lips 20 may be staggered, altered, or positioned as may be desired along the edges 40, 42 of the discontinuous region 18 such that the line 50 is retained in the central portion 34 of the tubular member 12.

Also, the discontinuous region 18 may have a first region 22 and a second region 24. The first region 22 may have a distance from the first edge 40 to the second edge 42 of the discontinuous region 18. Similarly, the second region 24 may have a distance from the first edge 40 top the second edge 42. The first region 22 may have a shorter distance between the edges 40, 42 than the second region 24, while both the first and second regions 40, 42 are aligned along the length of the discontinuous region 18.

Thus, the first region 22 having a small distance between the edges 40, 42, may be along one side of the discontinuous region 18 with the second region adjacent to the first region, where the second region has a larger distance between the two edges 40, 42. Thus, the user may insert the line 50 into the second region 24 easily and maneuver the line 50 through the first region 22 once the line is partially inserted into the central portion 34 of the discontinuous region 18.

The discontinuous region 18 may further include a third region 26. The third region 26 may also have a distance from the first edge 40 to the second edge 42 of the discontinuous region 18. The third region 26 may have a distance that is larger than the first region 22. The third region 26 and the second region 24 may have an equal distance, or may have different distances. Thus, in use, the first region 22 having a smaller distance between the edges 40, 42, may be sandwiched between the second and third regions 24, 26. This is shown, for example, in FIG. 2 and FIG. 7. With the first region 22 located between the second region 24 and the third region 26, the user may insert the line 50 into either or both of the second region 24 or the third region 26 where the distance between the edges 40, 42 is larger than the first region 22. The user may first position the line 50 into the larger second and third regions 24, 26, before pushing or pulling the line 50 through the smaller, first region 22.

The discontinuous region 18 may take other forms, including tapered, spline, wedged, serrated, uniform projections along the edges 40, 42, or a plurality of uniformly spaced ridges (or lips, or regions), etc. so long as the desirable property of removable attachment (i.e. the discontinuous region 18 is not completely closed) is promoted so that the line 50 may be worked out of the tubular member 12 without having to manipulate or apply pressure or force to the device 10 or tubular member 12. Similarly, one or more of the first, second, or third regions 22, 24, 26, may be tapered or sloped so that the insertion of the line 50 is easily accomplished.

In use, the discontinuous region 18 of the slidable fishing device 10 allows for the slidable fishing device 10 to be removably attached to a fishing line 50. Thus, there is no need to cut the fishing line 50, or to reattach the swivel snap, hook, lure, or other tackle devices when the device 10 is swapped out. There are no moving parts as with some other fishing devices, therefore, the device 10 will have a longer life in use.

Due to the ease in use, many users with limited physical capability, hand strength, and/or dexterity may use the present device 10 without problems, as there is no need to twist, turn, pinch, clamp, crimp, or apply pressure to the device 10 to seal the line 50 into the central portion 34 of the tubular member. Further, adding the line 50 to the slidable fishing device 10 may be done with one hand, as pressure from one hand or even a finger may be enough to secure the line 50 on the tubular member 12. In order to attach the line 50 to the slidable fishing device 10, the user may hold any portion of the device 10, including the tubular member 12, ring portion 30, or neck 28.

Thus, in use, the slidable fishing device 10 is capable of sliding up and down a length of deployed fishing line 50, with a sinker 52 attached thereon. The fisherman may then install the slidable fishing device 10 with a sinker 52 without having to cut the line 50. Similarly, the slidable fishing device 10 and/or the sinker 52 is removably attachable, so the line 50 need not be cut.

Thus, the present invention solves the problems of previous sinkers and has the advantages of employing an open design that allows removable attachment and the slidable accommodation of varying sized lines 50. Further, the present invention is installable over the existing tackle on the line, so the fisherman need not cut the line 50 with hook, etc, in order to install the slidable fishing device 10 and sinker 52. Once the fishing line is installed, the slidable fishing device 10 creates a moving part that actively adjusts as against the line 50 and in accordance with the slack in the line 50, water depth, et cetera.

The discontinuous region 18 is preferably about 90 degrees from the angle of the ring portion 30. Thus, the sinker 52 will generally pull the ring portion 30 to the bottom-most part of the device 10, while the line 50 will generally keep the opposed portion of the tubular member 12 in the upper-most position. Thus, it is desirable to have the discontinuous region away from the uppermost portion of the device 10 and the lower-most region of the device 10, near the ring portion 30, to minimize interference with the line and ring portion 30. In use, while the device 10 is installed with a sinker, a fish finder device will naturally fall in this position and therefore the probability of the line 50 coming out through the discontinuous region 18 is remote.

One or more of the elements and features described herein may be used in combination; the above-referenced embodiments do not serve as a limit to the elements and features employable herewith. While various embodiments of the present invention are specifically illustrated and/or described herein, it will be appreciated that modifications and variations of the present invention may be effected by those skilled in the art without departing from the spirit and intended scope of the invention. Further, any of the embodiments or aspects of the invention as described in the claims or throughout the specification may be used with one and another without limitation.

What is claimed is:

1. A slidable fishing device comprising:
a tubular member having an inner wall and an outer wall;
a discontinuous region longitudinally aligned along a side of said tubular member, said discontinuous region configured to allow passage of a line from the outer wall to the inner wall of said tubular member and retain said line therein;
a ring portion projecting from said tubular member, said ring portion configured to attach at least one tackle member, wherein said tubular member slidably retains said line along said inner wall.

2. The device of claim 1, further wherein said inner wall of said tubular member is dimensioned to slidably retain a plurality of sized lines.

3. The device of claim 1, wherein the discontinuous region comprises an open ferrule.

4. The device of claim 1, further wherein the ring portion is held to said tubular member by a neck region.

5. The device of claim 1, further wherein said ring portion has a ring slit to allow said tackle member to be positioned thereon and retained by said ring portion.

6. The device of claim 1, wherein the device has no moving parts.

7. The device of claim 1, wherein the discontinuous region includes a first region and a second region, said first region having a distance from a first edge of said discontinuous region to a second edge of said discontinuous region, and said second region having a distance from a first edge of said discontinuous region to a second edge of said discontinuous region, wherein the distance of the first region is lesser than the distance of the second region.

8. The device of claim 7, further comprising a third region having a distance from a first edge of said discontinuous region to a second edge of said discontinuous region, that is larger than said first region.

9. The device of claim 8, further wherein said first region is located between said second region and said third region along said discontinuous region.

10. The device of claim 7, further wherein at least one of said first region and said second region include a tapered portion.

11. The device of claim 1, further wherein the discontinuous region includes at least one lip extending along a portion thereof, said lip configured to allow entry of said line into a central portion of said tubular member and retain said line therein.

12. The device of claim 11, wherein the discontinuous region includes a plurality of lips along a first edge of said discontinuous region.

13. The device of claim 12, wherein the plurality of lips are along a first edge of said discontinuous region.

14. The device of claim 12, wherein the plurality of lips are along a first edge and a second edge of said discontinuous region.

15. The device of claim 1, further wherein the tackle component is selected from the group consisting of a sinker, a swivel, a swivel snap, a snap, a lock, a hook, a lure, a second portion of line, and combinations thereof.

16. The device of claim 1, further wherein said ring portion includes a neck portion to join the tubular member.

17. The device of claim 1, wherein the discontinuous region is located at a 90 degree or less angle from the ring portion.

18. The device of claim 1, wherein the device is composed of a materials selected from the group consisting of: lead, plastic, polymer, steel, metal, and combinations thereof.

19. The device of claim 1, wherein the ring portion is integral with the tubular member.

20. The device of claim 1, wherein the ring portion is attached to the tubular member.

21. A slidable fishing device comprising:
a generally tubular member having an inner wall and an outer wall;
a discontinuous region along said generally tubular member, said discontinuous region providing an open ferrule to said tubular member wherein said open ferrule is configured to allow the removable attachment of said slidable fishing device onto a line from the outer wall to the inner wall of said tubular member and retain said line therein; and
a ring portion projecting to said tubular member, said ring portion configured to attach to at least one tackle member, wherein said tubular member slidably retains said line along said inner wall.

22. A slidable fishing device comprising:
a tubular member having an inner wall and an outer wall;
a discontinuous region having a first region and a second region, said first region of said discontinuous region having a distance from a first edge to a second edge of said discontinuous region that is shorter than the first and second edge of the second region, wherein said discontinuous region is longitudinally aligned along a side of said tubular member and is configured to allow a line to pass into the central portion of the tubular member and be retained therein along the inner wall; and
a ring portion projecting to said tubular member, said ring portion configured to attach to at least one tackle member, wherein said tubular member slidably retains said line along said inner wall.
